(19) United States
(12) Patent Application Publication
(10) Pub. No.: US 2016/0246406 A1
(43) Pub. Date: Aug. 25, 2016

(54) TOUCH SENSING DEVICE AND CONCURRENT SENSING CIRCUIT

(71) Applicant: HIMAX TECHNOLOGIES LIMITED, Tainan City (TW)

(72) Inventors: Wei-Song Wang, Tainan City (TW); Yaw-Guang Chang, Tainan City (TW)

(21) Appl. No.: 14/626,777

(22) Filed: Feb. 19, 2015

(51) Int. Cl. G06F 3/044

(52) U.S. Cl. CPC G06F 3/044

(57) ABSTRACT

A concurrent sensing circuit adaptable to a touch panel, including a plurality of summing circuits, each of which has input ends for receiving sensing signals provided at associated receiving ends of the touch panel, the input ends of each summing circuit adding or subtracting the sensing signals, thereby generating a summing signal at an associated output end of the summing circuit; and a plurality of receiving circuits associatively coupled to receive output ends of the summing circuits, respectively, the receiving circuits processing summing signals, thereby generating summing values, respectively, according to which a touch position or positions are determined.

### BACKGROUND OF THE INVENTION

1. Field of the Invention

The present invention generally relates to touch sensing, and more particularly to a concurrent sensing circuit adaptable to a touch panel.

2. Description of Related Art

A touch sensing device may, for example, accompany a display to form a touch screen, which combines touch technology and display technology to enable users to directly interact with what is displayed. Capacitive touch sensing is one of a variety of touch sensing technologies with different methods of sensing touch.

A capacitive touch sensing device is comprised of a conductor (e.g., indium tin oxide) and an insulator (e.g., glass). When a human body, as an electrical conductor, touches a surface of the capacitive touch sensing device, electrostatic field is distorted and measurable as a change in capacitance, according to which the location of touch may be determined.

A mutual-capacitive touch sensing device is one type of capacitive touch sensing device. FIG. 1A shows a schematic diagram illustrated of a mutual-capacitance touch sensing device 100, which may be made up of row electrodes and column electrodes, for example, in 3-by-5 array as exemplified in FIG. 1A. Driving signals are applied to transmitting ends TX1-TX3, and sensing signals are collected at receiving ends RX1-RX5.

A self-capacitive touch sensing device is another type of capacitive touch sensing device. FIG. 1B shows a schematic diagram illustrated of a self-capacitance touch sensing device 102, which may be made up of row electrodes and column electrodes, for example, in 3-by-5 array as exemplified in FIG. 1B. Unlike the mutual-capacitance touch sensing device 100, the self-capacitance touch sensing device 102 has only receiving ends RX11-RX15 and RX21-RX23, at which sensing signals are collected.

In either the mutual-capacitance touch sensing device 100 or the self-capacitance touch sensing device 102, each receiving end (RX) is associatively coupled with one receiving circuit (or receiving unit) 11 such as an analog-to-digital converter (ADC). For the architecture shown in FIG. 1A or FIG. 1B, the number of the receiving circuits 11 should be equal to the number of the receiving ends. Therefore, the architecture suffers large circuit area and cost, particularly for a large size touch sensing device. The architecture shown in FIG. 1A or FIG. 1B may still be at a disadvantage for a small size touch sensing device that has limited space to accommodate the receiving circuits 11 and/or limited power available to the receiving circuits 11.

In order to resolve the problem mentioned above, a modified architecture is proposed as schematically illustrated in FIGS. 2A and 2B, in which less receiving circuits 11 (than the receiving ends (RX)) are used in a touch sensing device 200. Specifically, in the first phase as illustrated in FIG. 2A, sensing signals associated with a portion of the receiving ends (e.g., RX1-RX3) are received (and processed) by the receiving circuits 11. Subsequently, in the second phase as illustrated in FIG. 2B, sensing signals associated with the other portion of the receiving ends (e.g., RX4-RX6) are then received (and processed) by the same receiving circuits 11. As the receiving circuits 11 in FIG. 2A and FIG. 2B are used in a time-sharing manner, the architecture shown in FIG. 2A and FIG. 2B suffers long latency for processing all the sensing signals. This disadvantage becomes severer for an in-cell touch screen that performs display and touch sensing in turn, such that less time is available for touch sensing than a typical touch sensing device (e.g., FIG. 1A or FIG. 1B).

For the reason that conventional touch sensing devices suffer the disadvantage of large circuit area or long latency, a need has thus arisen to propose a novel scheme of touch sensing device to reduce circuit area without incurring long latency.

### SUMMARY OF THE INVENTION

In view of the foregoing, it is an object of the embodiment of the present invention to provide a concurrent sensing circuit adaptable to a touch panel to save circuit area and cost without incurring latency.

According to one embodiment, a touch sensing device includes a touch panel, a plurality of summing circuits and a plurality of receiving circuits. The touch panel is made up of row electrodes and column electrodes. Each summing circuit has a plurality of input ends for receiving a plurality of sensing signals provided at associated receiving ends of the touch panel, the input ends of each summing circuit adding or subtracting the sensing signals, thereby generating a summing signal at an associated output end of the summing circuit. The receiving circuits are associatively coupled to receive output ends of the summing circuits, respectively, the receiving circuits processing summing signals, thereby generating summing values, respectively, according to which a touch position or positions are determined.

### BRIEF DESCRIPTION OF THE DRAWINGS

FIG. 1A shows a schematic diagram illustrated of a mutual-capacitance touch sensing device;

FIG. 1B shows a schematic diagram illustrated of a self-capacitance touch sensing device;

FIG. 2A and FIG. 2B show schematic diagrams illustrated of a time-sharing touch sensing device;

FIG. 3 shows a schematic diagram illustrated of a touch sensing device according to one embodiment of the present invention;

FIG. 4 shows an exemplary timing sequence of the summing circuits of FIG. 3; and

FIG. 5 shows a circuit diagram illustrated of the summing circuit of FIG. 3.

### DETAILED DESCRIPTION OF THE INVENTION

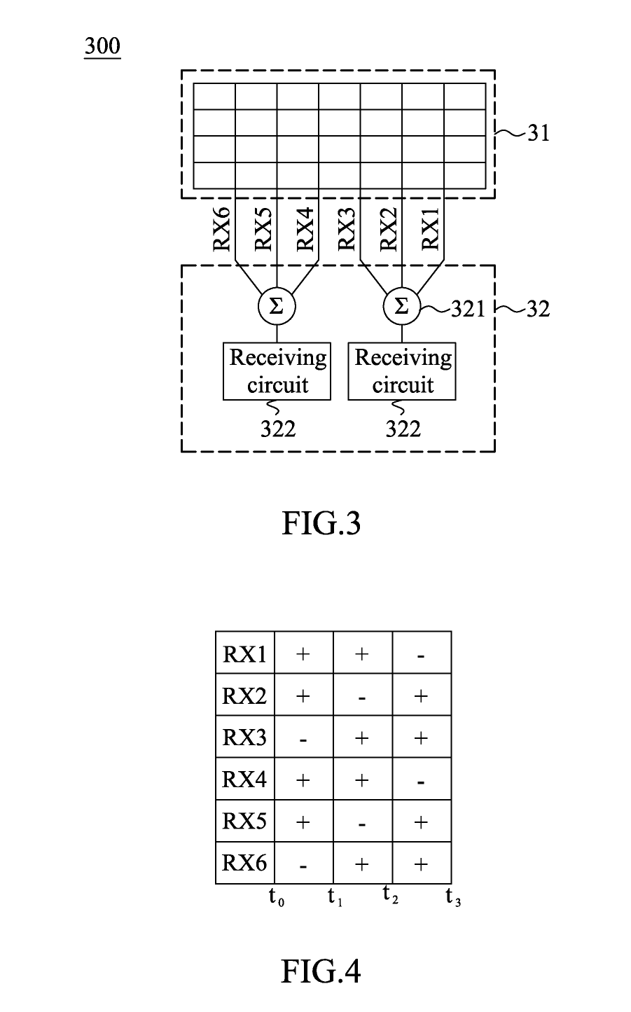

FIG. 3 shows a schematic diagram illustrated of a touch sensing device 300 according to one embodiment of the present invention. The touch sensing device 300 of the embodiment may, but not necessarily, accompany a display to form a touch screen.

The touch sensing device 300 of the embodiment includes a touch panel 31 and a concurrent sensing circuit 32 adaptable to the touch panel 31. The touch panel 31 may, for example, a resistive touch panel, a capacitive touch panel or an optical touch panel. The touch panel 31 may be made up of row electrodes and column electrodes, for example, in 3-by-6 array as exemplified in FIG. 3. In the embodiment, receiving ends RX1-RX6 are, for example, associated with column electrodes, and sensing signals may be provided (or generated) at the receiving ends RX1-RX6.

The concurrent sensing circuit 32 of the embodiment includes a plurality of summing circuits 321. Each summing circuit 321 has a plurality of input ends for receiving a plurality of sensing signals provided at associated receiving ends. For example, the right-hand summing circuit 321 in FIG. 3 has three input ends for receiving three sensing signals provided at associated receiving ends RX1-RX3. Similarly, left-hand summing circuit 321 in FIG. 3 has three input ends for receiving three sensing signals provided at associated receiving ends RX4-RX6. It is noted that each receiving end is associated with one and only one summing circuit 321. According to one aspect of the embodiment, the summing circuit 321 is adopted to add or subtract the sensing signals, thereby generating a summing signal at an associated output end.

The concurrent sensing circuit 32 of the embodiment further includes a plurality of receiving circuits (or receiving units) 322 such as analog-to-digital converters (ADCs). The receiving circuits 322 are associatively coupled to output ends of the summing circuits 321, respectively. In the embodiment, the number of the summing circuits 321 is equal to the number of the receiving circuits 322. The receiving circuit 322 is adopted to process the summing signal, thereby generating a summing value, according to which a touch position or positions may then be determined.

FIG. 4 shows an exemplary timing sequence of the summing circuits 321 of FIG. 3. Although the timing sequence for time t₀ to t₃ is depicted, it is appreciated that the following timing sequences would repeat the shown timing sequence. In the figure, RX1-RX6 denote associated sensing signals, respectively, “+” denotes that the summing circuit 321 performs addition on the associated sensing signal, and “−” denotes that the summing circuit 321 performs subtraction on the associated sensing signal. It is observed that, in the embodiment, the combinations of addition and subtraction operations associated with the input ends of the summing circuit 321 during three continuous time periods are distinct from each other. For example, the summing circuit 321 has a combination of “+,+,−” operations at time t₀, has a combination of “+,−,+” operations at time t₁, and has a combination of “−,+,+” operations at time t₂. Generally speaking, the combinations of addition and subtraction operations associated with n input ends of a summing circuit 321 during n continuous time periods are distinct from each other, where n is a positive integer larger than two.

Assume the right-hand summing circuit 321 has the summing values a, b and c (from the receiving circuit 322) in the three time periods shown in FIG. 4, the summing values a, b and c may be expressed as follows:

$$\{ \begin{matrix}RX 1 + RX 2 - RX 3 = a \\ RX 1 - RX 2 + RX 3 = b \\ - RX 1 + RX 2 + RX 3 = c\end{matrix} \\ or \\ [ \begin{matrix}+ 1 & + 1 & - 1 \\ + 1 & - 1 & + 1 \\ - 1 & + 1 & + 1\end{matrix} ] [ \begin{matrix}RX 1 \\ RX 2 \\ RX 3\end{matrix} ] = [ \begin{matrix}a \\ b \\ c\end{matrix} ]$$

After receiving the summing values a, b and c from the receiving circuit 322, the sensing signals RX1-RX3 may then be obtained accordingly.

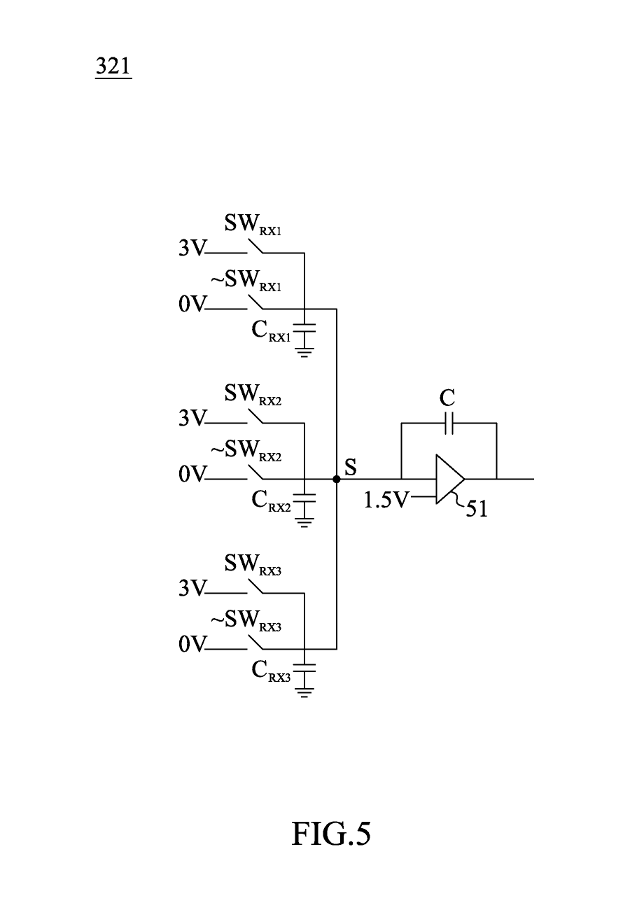

FIG. 5 shows a circuit diagram illustrated of the summing circuit 321 of FIG. 3. In the figure, C_{RX1}, C_{RX2} and C_{RX3} denote equivalent capacitances associated with the receiving ends RX1-RX3 of the touch panel 31. Regarding the input end associated with the receiving end RX1, a (first) switch SW_{RX1} is closed to receive a predetermined positive voltage (e.g., 3V) when an addition operation is performed, otherwise a (second) switch −SW_{RX1} is closed to receive the ground when a subtraction operation is performed. Similarly, regarding the input end associated with the receiving end RX2, a (first) switch SW_{RX2} is closed to receive a predetermined positive voltage (e.g., 3V) when an addition operation is performed, otherwise a (second) switch −SW_{RX2} is closed to receive the ground when a subtraction operation is performed. Further, regarding the input end associated with the receiving end RX3, a (first) switch SW_{RX3} is closed to receive a predetermined positive voltage (e.g., 3V) when an addition operation is performed, otherwise a (second) switch −SW_{RX3} is closed to receive the ground when a subtraction operation is performed.

The equivalent capacitances C_{RX1}, C_{RX2} and C_{RX3} associated with the receiving ends RX1-RX3 of the touch panel 31 are coupled at a point S, followed by an amplifier 51 (e.g., an operational amplifier). A capacitor C is coupled between an output end and an input end of the amplifier 51. The capacitor C is charged when an addition operation is performed, and is discharged when a subtraction operation is performed.

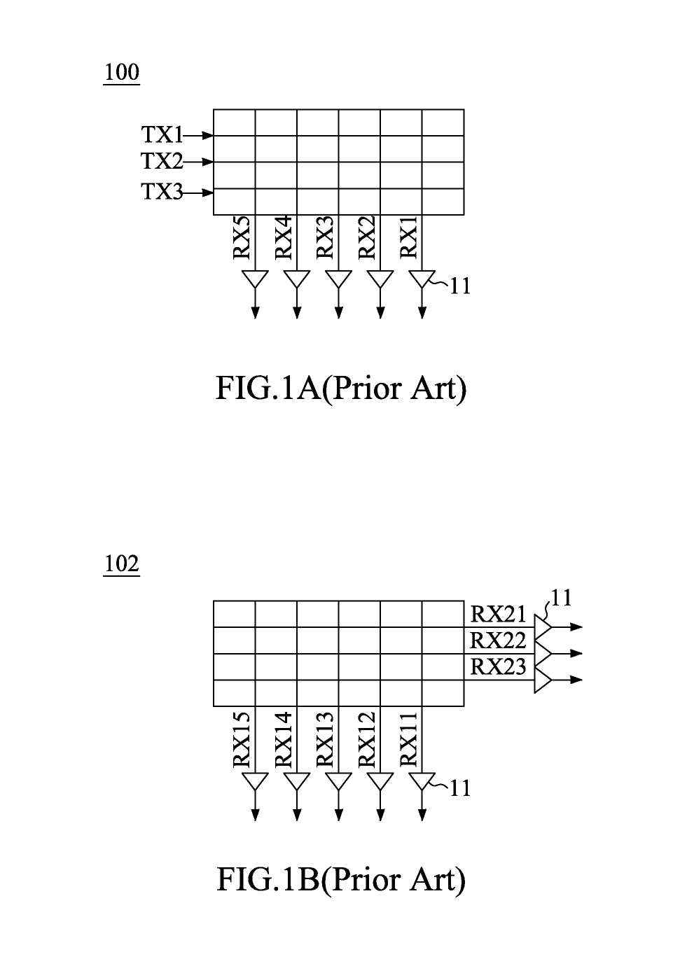

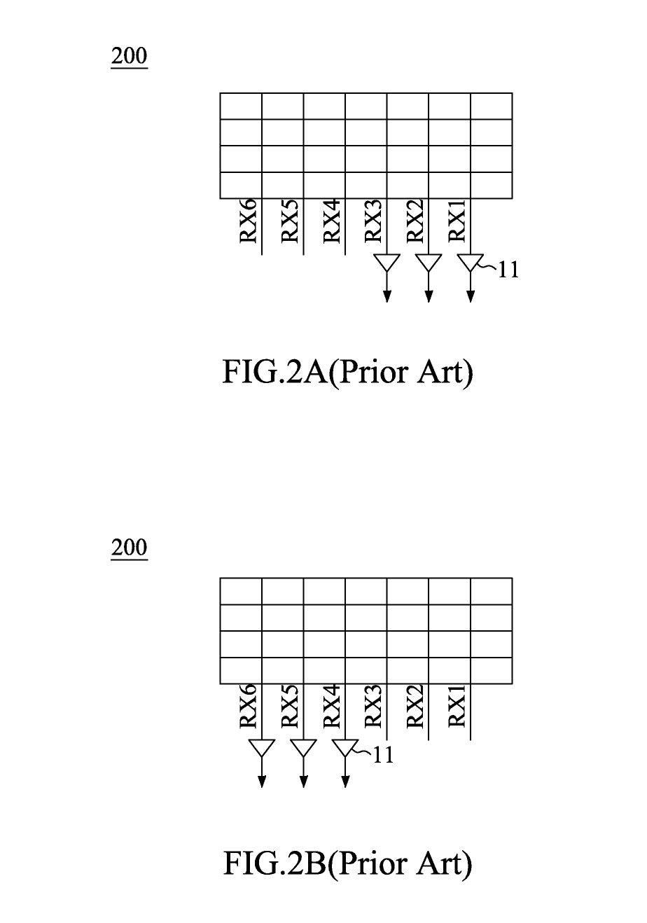

According to the embodiment disclosed above, as less receiving circuits 32 are used than the receiving ends, circuit area and cost may thus be saved, and the embodiment may thus be more adaptable for a large size touch sensing device compared to the architecture of FIG. 1A or FIG. 1B. Moreover, as all the sensing signals are processed by the receiving circuits 32 at the same time or concurrently, in stead of operating in a time-sharing manner as in FIGS. 2A/2B, the embodiment therefore does not suffer latency.

Although specific embodiments have been illustrated and described, it will be appreciated by those skilled in the art that various modifications may be made without departing from the scope of the present invention, which is intended to be limited solely by the appended claims.

What is claimed is:

1. A touch sensing device, comprising:
a touch panel made up of row electrodes and column electrodes;
a plurality of summing circuits, each of which has a plurality of input ends for receiving a plurality of sensing signals provided at associated receiving ends of the touch panel, the input ends of each summing circuit adding or subtracting the sensing signals, thereby generating a summing signal at an associated output end of the summing circuit; and
a plurality of receiving circuits associatively coupled to receive output ends of the summing circuits, respectively, the receiving circuits processing summing signals, thereby generating summing values, respectively, according to which a touch position or positions are determined.

2. The touch sensing device of claim 1, wherein each receiving end of the touch panel is associated with one and only one of the plurality of summing circuits.

3. The touch sensing device of claim 1, wherein each of the plurality of receiving circuits comprises an analog-to-digital converter.

4. The touch sensing device of claim 1, wherein a number of the summing circuits is equal to a number of the receiving circuits.

5. The touch sensing device of claim 1, wherein combinations of addition and subtraction operations associated with the input ends of the summing circuit during a plurality of continuous time periods are distinct from each other.

6. The touch sensing device of claim 1, wherein a combinations of addition and subtraction operations associated with n input ends of the summing circuit during n continuous time periods are distinct from each other, where n is a positive integer larger than two.

7. The touch sensing device of claim 1, wherein each summing circuit comprises:
a first switch associated with each input end, the first switch being closed to receive a predetermined positive voltage when an addition operation is performed;
a second switch associated with each input end, the second switch being closed to connect ground when a subtraction operation is performed;
an amplifier coupled with the first switch, the second switch and associated receiving ends of the touch panel; and
a capacitor coupled between an output end and an input end of the amplifier, such that the capacitor is charged when the addition operation is performed, and is discharged when the subtraction operation is performed.

8. A concurrent sensing circuit, comprising:
a plurality of summing circuits, each of which has a plurality of input ends for receiving a plurality of sensing signals provided at associated receiving ends of a touch panel, the input ends of each summing circuit adding or subtracting the sensing signals, thereby generating a summing signal at an associated output end of the summing circuit; and
a plurality of receiving circuits associatively coupled to receive output ends of the summing circuits, respectively, the receiving circuits processing summing signals, thereby generating summing values, respectively, according to which a touch position or positions are determined.

9. The concurrent sensing circuit of claim 8, wherein each receiving end of the touch panel is associated with one and only one of the plurality of summing circuits.

10. The concurrent sensing circuit of claim 8, wherein each of the plurality of receiving circuits comprises an analog-to-digital converter.

11. The concurrent sensing circuit of claim 8, wherein a number of the summing circuits is equal to a number of the receiving circuits.

12. The concurrent sensing circuit of claim 8, wherein combinations of addition and subtraction operations associated with the input ends of the summing circuit during a plurality of continuous time periods are distinct from each other.

13. The concurrent sensing circuit of claim 8, wherein a combinations of addition and subtraction operations associated with n input ends of the summing circuit during n continuous time periods are distinct from each other, where n is a positive integer larger than two.

14. The concurrent sensing circuit of claim 8, wherein each summing circuit comprises:
a first switch associated with each input end, the first switch being closed to receive a predetermined positive voltage when an addition operation is performed;
a second switch associated with each input end, the second switch being closed to connect ground when a subtraction operation is performed;
an amplifier coupled with the first switch, the second switch and associated receiving ends of the touch panel; and
a capacitor coupled between an output end and an input end of the amplifier, such that the capacitor is charged when the addition operation is performed, and is discharged when the subtraction operation is performed.
